(19) United States
(12) Patent Application Publication
(10) Pub. No.: US 2003/0220827 A1
(43) Pub. Date: Nov. 27, 2003

(54) System and Method for Scheduling Service Technicians

(76) Inventor: Neil Murphy, Falls Church, VA (US)

Correspondence Address: JEFFREY FURR, 253 N. MAIN STREET, JOHNSTOWN, OH, 43031, US

(21) Appl. No.: 10/249,950

(22) Filed: May 21, 2003

Related U.S. Application Data
(60) Provisional application No. 60/319,261, filed on May 21, 2002.

(51) Int. Cl. G06F 17/60

(52) U.S. Cl. 705/8

(57) ABSTRACT

A system designed for the scheduling of time, more specifically technicians time. The system allows the appointments be scheduled in one phone call instead of several. The system can schedule a plurality of the different companies' technicians in the one phone call. The system will send reminders by auto voice and email of the appointment before the appointment. The system in the preferred embodiment is all internet based. The system is designed for quick changes and interconnectivity with many devices.

### CROSS REFERENCE TO RELATED APPLICATIONS

This application claim the priority date of Provisional Patent 60/319,261 filed May 21, 2002.

### BACKGROUND OF INVENTION

1. Field of the Invention

This invention relates to the art of scheduling time on a system and more specifically, to the scheduling of technician's time, the efficient collection of monies owed for the technician's work, and the management of the customer relationship in general (CRM).

2. Description of Prior Art

The current means of scheduling technicians involves calling a service center and having someone at the center schedule a technician for a given day of the week when they are available. There is no convenient way to schedule multiple technicians from multiple vendors in a local area or nationwide. In the past, if you called customer service with a problem to be fixed in your home or business, you would get a call back the next day from the company that would actually be doing the work to set up the appointment.

With today's national and international business environment where companies' need to service clients who are across theroad, across the nation or across the sea there is a need for a system that can schedule multiple technicians from potentially multiple companies to service multiple client's needs. This system needs to be accessible and easy to use.

The need for a better method for scheduling technicians in a manner that is efficient, quick, inexpensive, and easy to use shows that there is still room for improvement within the art.

### SUMMARY OF INVENTION

The object of the present invention is to provide a method for a user to request and schedule a plurality of technicians for a service or maintenance call. The current invention allows for the appointment to be scheduled in one phone call, or a single sign-on, and schedules multiple companies' technicians. The system reminds the user by auto voice and/or email of the appointment ahead of the appointment time. In the preferred embodiment the system is Internet based and is designed for quick changes and interconnectivity with many devices.

The system is a scalable hardware and software system which improves customer service, call center and field service force efficiency through intelligent scheduling, tracking, reporting, and accounting of customer service calls and field assets. It performs the steps of: 1) Consolidation and automated retrieval of service provider and third-party service vendor data in a CMI/FieldPower database and the display of this data on a customer service screen in the customer contact center.

2) Automated addition of data to disparate database systems resulting from the customer contact session.

3) Data entry procedures and functionality for customer service agents and associated personnel regarding the trouble ticket, issue resolution status, and intelligent scheduling functionality.

4) Intelligent scheduling functionality in a single phone call, including the nearest location, optimized drive time, and directions, for a field service representative to reach an appointment.

5) Intelligent scheduling of third-party service vendors (e.g. VOLT, MCA, IFC and others), including nearest technician, single contact functionality for the customer, and customer record storage and updating in a database.

6) Third-party service vendor access to required customer, work assignment, and scheduling data, with data access levels defined by pre-determined authorizations and rules.

7) Service provider data security utilizing an extranet/DMZ system.

8) Automated voice and email reminders to customers of scheduled appointments.

9) Automated integration of customer email feedback.

10) Integrated accounting functionality provided in conjunction with financial software such as Oracle's Small Business Suite software, including two way interaction with other system databases. The integrated system provides complete accounting functionality and includes invoicing, statements, and collections as well as web and paper-based clearing of credit cards, checks, and other payment media.

11) Flexible reporting and auditing of customer records and other information contained in the system via Web interface and other means.

12) Mobile functionality including integrated devices (e.g. a pocket pc, laptop) to store and transmit data to and from the field, including technician schedules, repair and instruction manual, driving directions and maps, trouble ticket information, customer records, customer signatures, and payment recording and clearing.

13) Proprietary methodology for automating entry, retrieval, and updating of customer trouble ticket data from the LECs or Manufacturers or service centers, including reporting and outside wire trouble ticket management.

14) Proprietary methodology for customer self-scheduling of appointments via the Internet, IVR, email, and/or telephone contact.

15) Customer service representative-level database security system, maintained by a service provider (e.g. MCI WorldCom) and granting various levels of access to databases on the basis of pre-defined rules and authorizations.

16) Proprietary methodology for querying the customer, by email and/or automated voice response, to rate how well the work performed was done, and to report these responses via web reports.

17) Proprietary methodology for ordering and tracking parts from a variety from suppliers via the internet 18) Propriety interface between multiple manufacturers and service centers.

19) Propriety best choice algorithms to choose the best service center, weighting distance, past performance, and individual preference.

The process is more efficient, effective, accurate and functional than the current art.

GLOSSARY OF TERMS Browser: a software program that runs on a client host and is used to request Web pages and other data from server hosts. This data can be downloaded to the client's disk or displayed on the screen by the browser.

Client host: a computer that requests Web pages from server hosts, and generally communicates through a browser program.

Content provider: a person responsible for providing the information that makes up a collection of Web pages.

Embedded client software programs: software programs that comprise part of a Web site and that get downloaded into, and executed by, the browser.

Cookies: data blocks that are transmitted to a client browser by a web site.

Hit: the event of a browser requesting a single Web component.

Host: a computer that is connected to a network such as the Internet. Every host has a hostname (e.g., mypc.mycompany.com) and a numeric IP address (e.g., 123.104.35.12).

HTML (HyperText Markup Language): the language used to author Web Pages. In its raw form, HTML looks like normal text, interspersed with formatting commands. A browser's primary function is to read and render HTML.

HTTP (HyperText Transfer Protocol): protocol used between a browser and a Web server to exchange Web pages and other data over the Internet.

HyperText: text annotated with links to other Web pages (e.g., HTML).

IP (Internet Protocol): the communication protocol governing the Internet. Server host: a computer on the Internet that hands out Web pages through a Web server program.

URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.

UWU server: in connection with the present invention, a special Web server in charge of distributing statistics describing Web traffic. Visit: a series of requests to a fixed Web server by a single person (through a browser), occurring contiguously in time.

Web master: the (typically, technically trained) person in charge of keeping a host server and Web server program running.

Web page: multimedia information on a Web site. A Web page is typically an HTML document comprising other Web components, such as images.

Web server: a software program running on a server host, for handing out Web pages.

Web site: a collection of Web pages residing on one or multiple server hosts and accessible through the same hostname (such as, for example, www.lucent.com).

### BRIEF DESCRIPTION OF DRAWINGS

Without restricting the full scope of this invention, the preferred form of this invention is illustrated in the following drawings:

FIG. 1 shows an overview of how a User and Service provider accesses the system through the Internet;

FIG. 2 shows a sample of the system web page;

FIG. 3 shows the standard logon web page; and

FIG. 4 shows the System Architecture.

### DETAILED DESCRIPTION

The preferred embodiment of the invention is a process consisting of a system of a scalable hardware and software system which improves customer service, call center and field service force efficiency through intelligent scheduling, tracking, reporting, and accounting of customer service calls and field assets. It performs the steps of:

1) Consolidation and automated retrieval of service provider and third-party service vendor data in a CMI/FieldPower database and the display of this data on a customer service screen in the customer contact center.

2) Automated addition of data to disparate database systems resulting from the customer contact session.

3) Data entry procedures and functionality for customer service agents and associated personnel regarding the trouble ticket, issue resolution status, and intelligent scheduling functionality.

4) Intelligent scheduling functionality in a single phone call, including the nearest location, optimized drive time, and directions, for a field service representative to reach an appointment.

5) Intelligent scheduling of third-party service vendors (e.g. VOLT, MCA, IFC and others), including nearest technician, single contact functionality for the customer, and customer record storage and updating in a database.

6) Third-party service vendor access to required customer, work assignment, and scheduling data, with data access levels defined by pre-determined authorizations and rules.

7) Service provider data security utilizing an extranet/DMZ system.

8) Automated voice and email reminders to customers of scheduled appointments.

9) Automated integration of customer email and DTMF recordedfeedback.

10) Integrated accounting functionality provided in conjunction with financial software such as Oracle's Small Business Suite software, including two way interaction with other system databases. The integrated system provides complete accounting functionality and includes invoicing, statements, and collections as well as web and paper-based clearing of credit cards, checks, and other payment media.

11) Flexible reporting and auditing of customer records and other information contained in the system via Web interface and other means.

12) Mobile functionality including integrated devices (e.g. a pocket pc, laptop) to store and transmit data to and from the field, including technician schedules, driving directions and maps, trouble ticket information, customer records, customer signatures, and payment recording and clearing.

13) Proprietary methodology for automating entry, retrieval, and updating of customer trouble ticket data from the LECs or Manufacturers or service centers, including reporting and outside wire trouble ticket management.

14) Proprietary methodology for customer self-scheduling of appointments via the Internet, IVR, email, and/or telephone contact.

15) Customer service representative-level database security system, maintained by a service provider (e.g. MCI WorldCom) and granting various levels of access to databases on the basis of pre-defined rules and authorizations.

16) Proprietary methodology for querying the customer, by email and/or automated voice response, to rate how well the work performed was done, and to report these responses via web reports.

17) Proprietary methodology for ordering and tracking parts from a variety from suppliers via the internet 18) Propriety interface between multiple manufacturers and service centers.

19) Propriety best choice algorithms to choose the best service center, weighting distance, past performance, and individual preference.

The system 1 has an Intelligent combination of appointment calendar and distance calculator. By entering a zip code, the service provider is shown the distance from the customer on the phone and all other appointments he has for the next 30 days, enabling best choice of schedule to minimize drive time

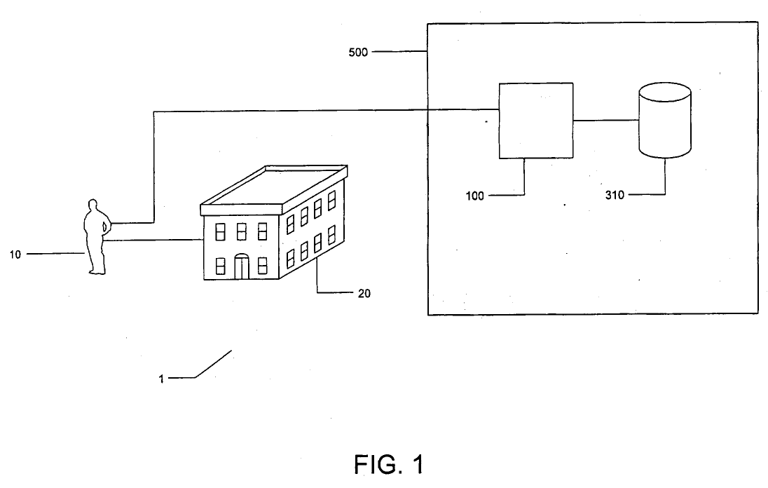

The System 1 is a leading global online network for technician scheduling. FIG. 1 illustrates a functional diagram of a computer network for World Wide Web 500 access to, the system 1 from a plurality of Users 10 who call a call center 20 who access the system web site 100 or the Users 10 can connected directly to the System 1. Accessing the System Web Site 100 can be accomplished directly through a communication means such as a direct connection, a intranet, a local Internet Service Provider, often referred to as ISPs, or through an on-line service provider like CompuServe, Prodigy, American Online, etc.

The Service Providers 20 contact the System Web site 100 using an informational processing system capable of running an HTML compliant Web browser such as Microsoft's Internet Explorer, Netscape Navigator, Lynx and Mosaic. A typical system that is used is a personal computer with an operating system such as Windows 95, 98 or ME or Linux, running a Web browser. The exact hardware configuration of computer used by the Service Providers 20, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

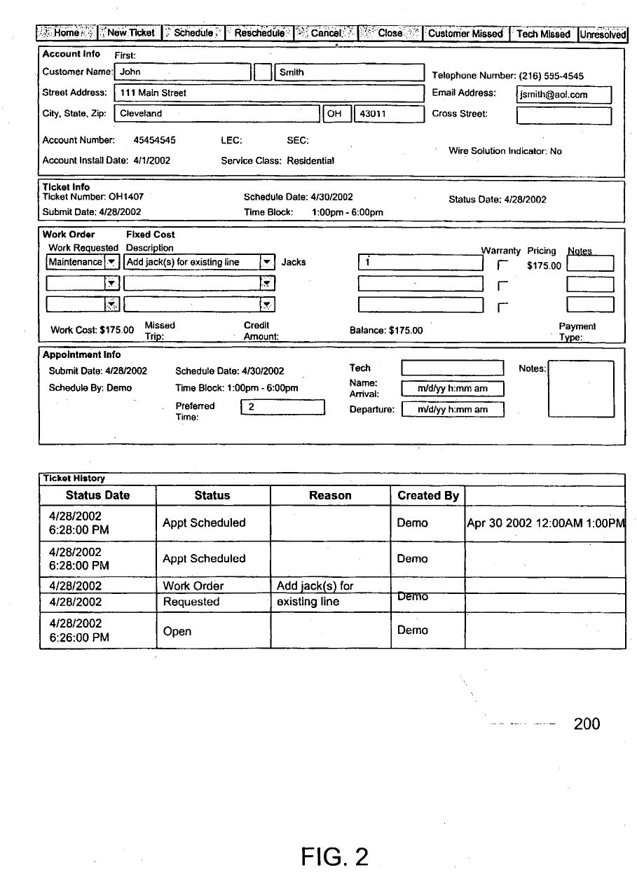

In one preferred embodiment of the invention, the Users 10 and/or Service Providers 20 connect to the System Web Site 100. FIG. 2 displays the Web Site 100 sample web page 200. In the preferred embodiment the system has numerous web pages. These are home, new ticket, schedule, reschedule, cancel, close, customer missed, tech missed and unresolved. The information in the web pages are in HTML format via the HyperText Transport Protocol (http) and on Server System 310. The Server System 310 is configured to generate cookies and to transfer the cookies to the User System. The User System 110 includes software to allow viewing of web pages, commonly referred to as a Web Browser, such as Communicator available from Netscape Communications Corp. or Internet Explorer available from Microsoft Corp. The user system is capable of accessing web pages located on Server System 310.

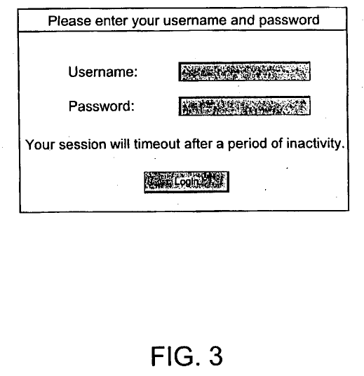

The system 1 would have a standard logon web as shown in FIG. 3. There would be a data entry field for Username and Password. The Username would have to be unique and the password would have to be at least eight characters. The web page will have a mechanism for Users 10 who forget their passwords. This technology is well known in the art and therefore is not covered in great detail here.

The home web page contains information about the system 1 and the site 100 and hyper-text transfers to the other web pages. It would be set up as a standard type of home. This technology is also well known in the art.

The New Ticket web page is the web page where a Service Provider 20 would enter the information about a new issue or maintenance to be scheduled. The customer name and address and other such information would be looked up from a customer database. If the customer is new then the customer information is added to the system. The customer would have an account number and additional account information. Information about the needs of the customer is entered and a ticket number is generated. In the preferred embodiment the ticket number is sequential and geographically based. The ticket information is stored in a ticket database and contains such information as ticket number, submit date, schedule date, time block and status date of the ticket.

The system 1 generates a work order which contains the type of work requested, a brief description, quantity, warranty indicator, pricing and notes. The work requested and brief description are inputted by the service provider 20 and can be pull down lines. The quantity, warranty indicator and notes are also inputted by the service provider 20. The pricing is generated by the system based on the information inputted.

The system 1 generates a ticket history with the different events and activities for the ticket. The ticket history is part of the ticket database and has the fields of status date, status, reason, created by and date the record was created. There can be multiple event records for a ticket.

The Schedule web page allows the Service Provider 20 to schedule a plurality of technicians for the user 10. The Schedule web page will be attached to the schedule database which has the schedules and available times for each technician. The technicians can be from multiple companies that provide the type of service needed. The system 1 shows the available of the technician in a given area. One of the ways the system 1 will select is by the area code and phone number given so that technicians in Cleveland will not show up as available for Washington D.C. . . . The distance between service provider and caller is calculated so as to provide the closet technician to the work, and also takes into consideration other work already scheduled in the area, so as to minimize the expense of drive time and down time. The Service Provider 20 will select the number of technicians available when the user 10 needs them and will schedule they time. These times are usually set as time blocks with a preferred time given. The system 1 may pull schedule information from numerous companies scheduling systems. It will also write to these systems once the time has been scheduled.

The Reschedule web page is set up to allow the rescheduling of a service technician if need be. It will modify the schedule database.

The cancel web page will cancel a scheduled time for a service technician. If that technician is available it will open that time slot as available for scheduling in the schedule database.

The close web page will allow the service provider 20 to close out a ticket. It will read and write to the ticket database.

The customer missed web page will allow a service provider 20 to add to the ticket database information on when a customer missed a scheduled time.

The Tech missed web page will allow a service provider 20 to add to the ticket database information on when a technician missed a scheduled time.

The unresolved web page allows the service provider 20 to enter information on a ticket that is unresolved after a technician's visit.

The system 1 will allow the tracking and scheduling of a company's allowing for the consolidation and automated retrieval of service provider and third-party service vendor data in a database and the display of this data on a customer service screen in the customer contact center.

The system 1 there its website 100 will allow for the automated addition of data to disparate database systems resulting from the customer contact session.

The system 1 allows for the intelligent scheduling functionality in a single phone call from a user 10, the processing means takes the nearest location, optimized drive time, and directions, for a field service representative to reach an appointment into account when scheduling appointments for the technicians. The system will use this intelligent scheduling with third-party service vendors (e.g. VOLT, MCA, IFC and others). These third-party service vendors will have access to required customer, work assignment, and scheduling data, with data access levels defined by pre-determined authorizations and rules. These pre-determined authorizations and rules are also set for Users 10 who access the system 1 directly. In the preferred embodiment the system's 1 service provider data security will utilize an extranet/DMZ system.

The system 1 will generate automated voice and email reminders to customers of scheduled appointments. These messages will be generated through automated systems.

The system 1 will have the automated integration of customer email feedback. Feedback E-mail written from the customers will be processed and stored on the system's 1 database allowing the service provider 20 to know where potential service issues are.

The system 1 will have the functionality of an integrated accounting functionality provided in conjunction with financial software such as Oracle's Small Business Suite software, including two way interaction with other system's databases. The integrated system provides complete accounting functionality and includes invoicing, statements, and collections as well as web and paper-based clearing of credit cards, checks, and other payment media.

The system 1 generates flexible reporting and auditing of customer records and other information contained in the system via the web interface and other means such as E-mail or hard copies.

The system 1 will have mobile functionality by connecting to and communicating with integrated devices (e.g. a pocket pc, laptop) to store and transmit data to and from the field, including technician schedules, driving directions and maps, trouble ticket information, customer records, customer signatures, and payment recording and clearing.

The system 1 employs a customer service representative-level database security system, maintained by an administration granting various levels of access to databases on the basis of pre-defined rules and authorizations. These levels are used by the processing means and are stored on a memory means.

The system 1 will use methodology for ordering and tracking parts from a variety from suppliers via the internet.

The system 1 will interface between multiple manufacturers and service centers.

The system 1 will use best choice algorithms to choose the best service center, weighting distance, past performance, and individual preference.

The system 1 has an Intelligent combination of appointment calendar and distance calculator. By entering a zip code, the service provider is shown the distance from the customer on the phone and all other appointments he has for the next 30 days, enabling best choice of schedule to minimize drive time.

Alternative Embodiments In an alternative embodiment, the System 1 could be used for other types of commodities besides technicians such as salesperson, consultants, accountants or security officers, or even non-personnel such as time lots for advertisements for television or radio.

The system 1 can be designed so that it can provide services to a single service provider at that service provider's site and location.

The system 1 can also be used in “similar” environment such as the consumer electronics industry. The system 1 in these applications are similar only in that it is using the dispatching and scheduling as telecommunications. The system 1 exchanges information between companies and hundred of the service centers through the country that repair the company's products. In addition, this version of the system 1 has built in invoicing and parts ordering, and individual technician work force management.

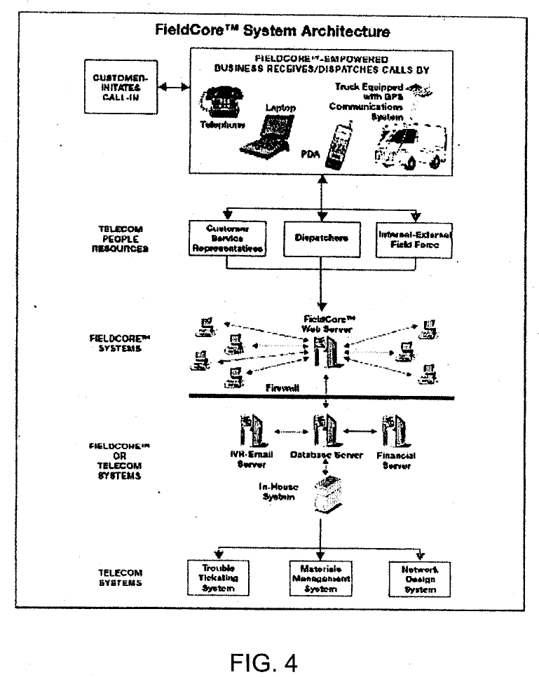

FIG. 4 is a diagram from of the system 1 architecture from the telecom side.

Advantages The previously described version of the present invention has many advantages. The intent is to develop a better method for the scheduling of technicians from a plurality of service provide/s that is efficient, accurate, quick, inexpensive, and easy to use, showing there is still room for improvement within the art.

Although the present invention has been described in considerable detail with reference to certain preferred versions thereof, other versions are possible. For example, the functionality and look of the web site could use different or new protocols or an Intranet could be used. Therefore, the point and scope of the appended claims should not be limited to the description of the preferred versions contained herein.

That which is claimed is:

1. A system for scheduling items comprising:
a plurality of Users connecting to the system;
said system having a memory means and a processing means; and
said memory means containing information on the availability of the desire item.

2. A system of claim 1 which is for the scheduling of service people.

3. A system of claim 1 which is for the scheduling of parts.

4. A system of claim 1 in which said system in connected to a plurality of users through the internet.

5. A system of claim 1 in which said system generates a work order.

6. A system of claim 1 in which said system generates a ticket history.

7. A system of claim 1 in which said system allows the scheduling of a plurality of items from a plurality of sources.

8. A system of claim 1 in which said system allows for automated customer feedback.

9. A system of claim 1 in which said system communicates with integrated devices.

10. A system of claim 1 in which said system has an integrated accounting function.

11. A system of claim 1 in which said system generates reporting.

12. A system of claim 1 in which said system generates reporting which is communicated via a web interface.

13. A system of claim 1 in which said system has a web interface.

14. A system of claim 1 in which said system allows the user to schedule a item based on its availability.

15. A system of claim 1 in which said system allows the user to select an item based on a geographical indicator such as a zip code or area code.

16. A system of claim 1 in which said user can access the system through a local area network.

17. A system of claim 1 in which said user can cancel a request.

18. A system of claim 1 in which said system uses specific input such as weighting distance, past performance, and individual preference to choose the best service center.

19. The system 1 of claim 1 which said system uses an combination of appointment calendar and distance calculator so that when a User enters a zip code, said User is shown the distance enabling best choice of schedule to minimize drive time.

20. A system for scheduling items comprising: a plurality of Users connecting to the system; said system having a memory means and a processing means; said memory means containing information on the availability of the desire item; said system is connect to a plurality of Users through a connection means; said system generates a work order; said system generates a ticket history; said system allows the scheduling of a plurality of items from a plurality of sources; said system allows the user to schedule a item based on its availability; and said system allows the user to select an item based on a geographical indicator such as a zip code or area code.
